(19) United States
(12) Patent Application Publication
(10) Pub. No.: US 2008/0007789 A1
(43) Pub. Date: Jan. 10, 2008

(54) Systems and methods for secure fax transmission status notification

(75) Inventor: Louis Ba La, Webster, NY (US)

Correspondence Address: PILLSBURY WINTHROP SHAW PITTMAN, LLP, P.O. BOX 10500, MCLEAN, VA, 22102, US

(73) Assignee: Xerox Corporation, Stamford, CT (US)

(21) Appl. No.: 11/482,895

(22) Filed: Jul. 10, 2006

(51) Int. Cl. H04N 1/00

(52) U.S. Cl. 358/400

(57) ABSTRACT

The presently disclosed embodiments are directed to systems and method for transmitting a secure electronic fax transmission report for a fax job from a fax capable printer to a user or recipient and sending commands for resubmitting or deleting the fax job from the user to the fax capable printer. One embodiment is a method for electronically transmitting a fax transmission report for a fax job from a fax capable printer. An email address is received for the user or the recipient. A recipient fax number is received. A document is scanned and an electronic representation of the document is transmitted to the recipient fax number as a fax job. The fax transmission report is generated. The fax transmission report includes the status of the fax job. An email including the fax transmission report is transmitted to the email address of the user or the recipient.

### BACKGROUND

1. Technical Field

The presently disclosed embodiments are directed to systems and methods for secure fax transmission status notification. More specifically, these disclosed embodiments include systems and methods for transmitting a secure electronic fax transmission report for a fax job from a fax capable printer to a user or recipient and sending commands for resubmitting or deleting the fax job from the user to the fax capable printer.

2. Description of Related Art

Conventionally, a fax capable printer prints out a fax transmission report page for each fax job. The fax transmission report page, for example, shows the status of the fax transmission and provides a copy of the first page of the fax job. Even though printing a fax transmission report page provides adequate feedback to a user, it is often inefficient and inconvenient. In addition, printing a fax transmission report page can result in several management issues, including the issue of confidentiality.

A fax capable printer can take as much time as three to five minutes to print out a fax transmission page. Waiting by a printer for three to five minutes for a fax transmission report page is not an efficient use of time for many users. As a result, these users usually walk away from the machine to carry on other business and check for the fax transmission report page sometime later.

This method of obtaining fax transmission notification is inconvenient and can even result in missed deadlines for important faxes. Not all fax jobs are successfully transmitted on the first attempt. Consequently, a user who has left the fax capable printer sometimes returns to find a fax transmission report page reporting that the transmission of fax job has failed. If the deadline for receiving this failed fax job has passed, this notification method can also be costly to a business.

Finally, printing a fax transmission report page that contains information about the fax job can expose sensitive or confidential information to anyone with access to the fax capable printer. For example, some employee benefit service providers, like flexible medical spending account managers, require employees to fax paperwork to them without a cover sheet. If a fax transmission report page prints the first page of a flexible spending account form, it can expose highly confidential information such as an employee's social security number, full name, home address, date of birth, and signed signature. Such highly confidential information is all that is needed for someone to commit identity theft.

### SUMMARY

One embodiment is a method for electronically transmitting a fax transmission report for a fax job from a fax capable printer. An email address is received. A recipient fax number is received. The document is scanned and an electronic representation of the document is transmitted to the recipient fax number as a fax job. The fax transmission report is generated. The fax transmission report includes the status of the fax job. An email including the fax transmission report is transmitted to the email address.

Another embodiment is a system for electronically transmitting a fax transmission report for a fax job from a fax capable printer. The system includes a user interface, a fax service, an email service, and a job manager. The user interface, fax service, email service, and job manager are software components that are executed on one or more processors of the fax capable printer. The user interface receives an email address, receives a recipient fax number, and receives a signal to fax a document. The job manager receives the email address, the recipient fax number, and the signal to fax the document from the user interface. The job manager transmits the document to the recipient fax number as a fax job by sending the recipient fax number to the fax service. The job manager monitors the fax service for the status of the fax job. The job manager generates the fax transmission report. The fax transmission report includes the status of the fax job. The job manager transmits an email, which includes the fax transmission report, to the email address by sending the email address and the fax transmission report to the email service.

Another embodiment is a method for storing a fax job on a fax capable printer. A recipient fax number is received. A first signal to save the fax job is received. A second signal to fax a document is received. The document is transmitted to the recipient fax number as a fax job. Transmitting the document to the recipient fax number includes creating a scanned image of the document and storing the recipient fax number, the scanned image, and a status of the transmitting the document as a fax job in a memory of the fax capable printer.

Other objects, features, and advantages of the present application will become apparent from the following detailed description, the accompanying drawings, and the appended claims.

### BRIEF DESCRIPTION OF THE DRAWINGS

FIG. 1 is a flowchart showing a method for faxing documents, in accordance with an embodiment.

FIG. 2 is a flowchart showing a method for receiving confirmation of a fax transmission, in accordance with an embodiment.

FIG. 3 is a flowchart showing a method for remotely retransmitting a fax using a Web service without having to rescan the same documents again, in accordance with an embodiment.

FIG. 4 is a flowchart showing a method for locally retransmitting a fax using information stored on the fax capable printer without having to rescan the same documents again, in accordance with an embodiment.

FIG. 5 is a flowchart showing a method for electronically transmitting a fax transmission report for a fax job from a fax capable printer using email, in accordance with an embodiment.

FIG. 6 is a schematic diagram of a system for electronically transmitting a fax transmission report for a fax job from a fax capable printer using email, in accordance with an embodiment.

FIG. 7 is a schematic diagram of a system for electronically transmitting a fax transmission report for a fax job from a fax capable printer using email showing the components of a fax service, in accordance with an embodiment.

FIG. 8 is a flowchart showing a method for storing a fax job on a fax capable printer, in accordance with an embodiment.

Before one or more embodiments are described in detail, one skilled in the art will appreciate that an embodiment is not limited in its application to the details of construction, the arrangements of components, and the arrangement of steps set forth in the following detailed description or illustrated in the drawings. An embodiment is capable of being practiced or being carried out in various ways. Also, it is to be understood that the phraseology and terminology used herein is for the purpose of description and should not be regarded as limiting.

### DETAILED DESCRIPTION

The word “printer” as used herein encompasses any apparatus, such as a digital copier, bookmaking machine, facsimile machine, multi-function machine, etc. which performs a print outputting function for any purpose. A “fax” or “facsimile” may be defined as an arrangement by which data relating to an image is sent through an electronic system, such as wire telephone, cell-phone system, or combination of aspects thereof, also generally usable for transmission of data relating to sound. The term “fax capable printer” refers to a device that has the capability to (a) print as a printer, and (b) scan a document into digital format and transmit the data in analog or digital format (including the raw scanned data or compressed data) to a remote location, such as by an analog (e.g., telephone line) or digital (e.g., the Internet) communication system. Typically, in the context of a typical fax machine, only the confirmation page is printed, but this still qualifies as a print capability. Embodiments disclosed herein may be practiced in other systems with both fax and print capabilities.

In one embodiment, an electronic notification is sent from a fax capable printer after a successful or failed fax transmission. When preparing to fax the document, a user enters an email address on the same user interface and in the same vicinity as the user enters a recipient fax number. The email address is the email address of the user or the email address of the recipient. The user can optionally enable or disable the printing of a fax transmission report page by the fax capable printer. The user can also optionally select or deselect an auto retry option to be applied if the initial fax transmission fails.

After entering the selections, the user initiates the fax transmission. The fax transmission is initiated by depressing a button on the fax capable printer, for example. The fax capable printer then monitors the fax job for a status and generates a fax transmission report. The fax transmission report is emailed to the email address entered by the user. A recipient preferably receives a fax transmission report via email only if the fax transmission was successful. An email to a recipient also preferably includes a brief, generic or personalized message that indicates to the recipient that a document is waiting at the recipient's fax machine. The fax transmission report is also printed by the fax capable printer depending on the option selected by the user.

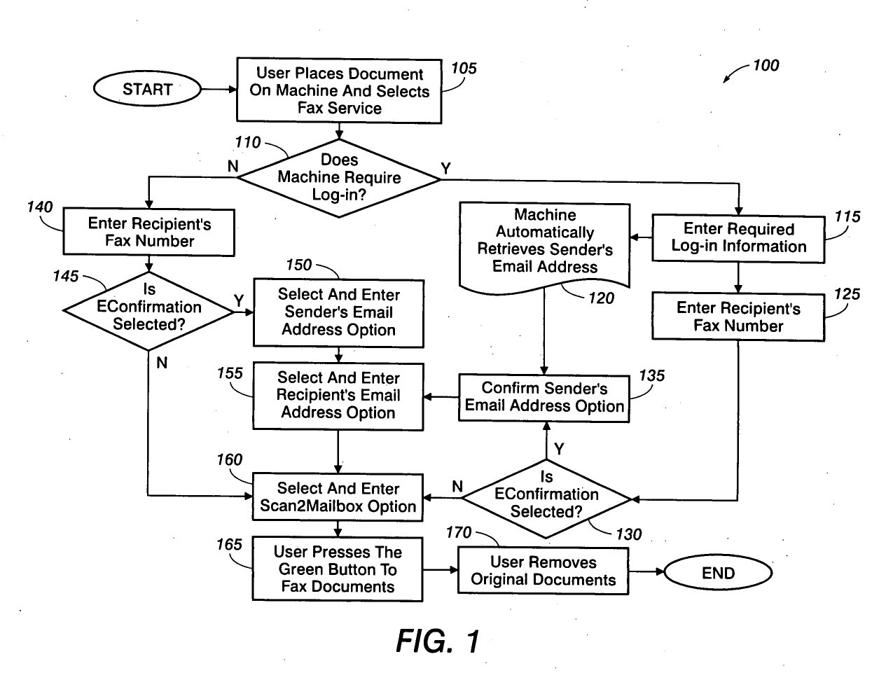

FIG. 1 is a flowchart showing a method 100 for faxing documents, in accordance with an embodiment.

In step 105 of method 100, a user places a document on a fax capable printer and selects an option to fax the document. The selection is made from a user interface of the fax capable printer, for example. A user interface of the fax capable printer can include, but is not limited to, a display, a graphical user interface provided on a display, a keypad, and/or input buttons.

In step 110, it is determined if the fax capable printer requires login information.

In step 115, login information is obtained from the user, if the fax capable printer requires login information. Login information can include, but is not limited to, a user identification (ID) and password. The login information is entered by the user using a user interface of the fax capable printer, for example.

In step 120, an email address for the user is obtained from a database according to the login information entered by the user in step 115. The database can be located on the fax capable printer or accessed remotely via a network connected to the fax capable printer.

In step 125, the recipient fax number is obtained from the user. The fax is being sent to the recipient. The recipient fax number is entered by the user using a user interface of the fax capable printer, for example. The term “fax number” will typically be a telephone number associated with the remote destination (e.g., a fax receiving machine), where the fax is to e sent. It may also be an email or other type of electronic address. The term “fax number” may encompass all of these.

In step 130, it is determined if the user has selected the electronic notification or confirmation option. Electronic confirmation is called “EConfirmation,” for example. The user selects electronic confirmation using a user interface of the fax capable printer, for example.

In step 135, the user is asked to confirm the email address obtained from the database in step 120, if electronic confirmation was selected by the user. The user confirms the email address using a user interface of the fax capable printer, for example.

In step 140, the recipient fax number is obtained from the user, if the fax capable printer does not require login information. The recipient fax number is entered by the user using a user interface of the fax capable printer, for example.

In step 145, it is determined if the user has selected the electronic confirmation option. The user selects electronic confirmation using a user interface of the fax capable printer, for example.

In step 150, an email address for the user is obtained from the user, if the electronic confirmation option was selected by the user and an option to notify the user by email was selected by the user. The email address for the user is used to notify the user of the status of the fax transmission. The email address for the user is entered by the user using a user interface of the fax capable printer, for example.

In step 155, an email address for the recipient is obtained from the user, if the electronic confirmation option was selected by the user and an option to notify the recipient by email was selected by the user. The email address for the recipient is used to notify the recipient of the status of the fax transmission. The email address for the recipient is entered by the user using a user interface of the fax capable printer, for example.

In step 160, a signal is received to store the fax job locally and its status on the fax capable printer, if the user selects the store fax job option. The store fax job locally option is called “Scan2Mailbox,” for example. The store fax job option is selected by the user using a user interface of the fax capable printer, for example. The store fax job locally option allows a user to return to the fax capable printer and resubmit the fax job without having to rescan the same documents.

The fax job can also be stored locally in step 130 when a user selects electronic confirmation. Electronic confirmation allows the sender to resubmit the fax job without having to return to the fax capable printer. In other words, electronic confirmation allows the user to remotely retransmit the same fax job without having to rescan the same documents.

In step 165, a signal is received to fax one or more documents and the one or more documents are faxed to the recipient fax number. The signal is obtained by the user pressing a button on the fax capable printer, for example. In another embodiment, the button is part of the user interface of the fax capable printer.

In step 170, the user removes one or more documents from the fax capable printer.

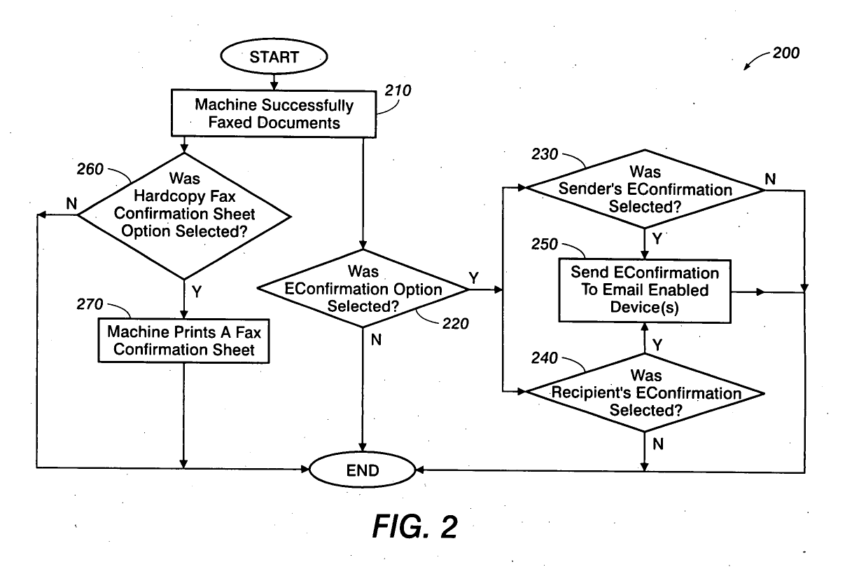

FIG. 2 is a flowchart showing a method 200 for receiving confirmation of a fax transmission, in accordance with an embodiment.

In step 210 of method 200, a fax capable printer has successfully transmitted a fax.

In step 220, it is determined if the user has selected the electronic confirmation option.

In step 230, it is determined if the user selected sending an electronic confirmation to the sender or user. If the user selected sending an electronic confirmation to the sender, the user would have entered an email address for the user, or the email address would have been obtained from a database using login information.

In step 240, it is determined if the user selected sending an electronic confirmation to the recipient. If the user selected ending an electronic confirmation to the recipient, the user would have entered an email address for the recipient.

In step 250, an electronic confirmation is sent, if the user selected sending an electronic confirmation to the sender or if the user selected sending an electronic confirmation to the recipient. An electronic confirmation is sent to both the user and the recipient, if the user selected sending an electronic confirmation to the sender and the user selected sending an electronic confirmation to the recipient. The electronic confirmation can be received by the user or the recipient at any email enabled device. An emailed enabled device can include, but is not limited to, a computer, a cellular phone, and a personal digital assistant. An email may include any electronically sent message, and may include typical emails and other messaging such as instant messaging or text messaging.

In step 260, it is determined if the user selected printing a fax confirmation sheet, or a fax transmission report page, by the fax capable printer.

In step 270, the fax confirmation sheet is printed by the fax capable printer.

In another embodiment, the email that is sent to the email address also includes a link, hyper-link, or universal resource locator (URL), to the fax capable printer's Web server if the email address is the email address of the user. The link allows the user to run a Web service to retrieve fax job information, including all previously entered selections. A Web service can also allow the user to view the recipient fax number, edit the recipient fax number, retransmit the fax, or delete the fax job from the fax capable printer. The link is preferably included if the fax transmission failed. However, the link can also be sent if the fax transmission is successful. A user can decide to resend a successful fax to the same recipients or other recipients, for example.

In another embodiment, the link is included in an email sent to the email address of the recipient. However, a Web service providing retransmission of the fax is preferably not available to a recipient. A user or recipient accesses a link and executes a Web service using a Web browser.

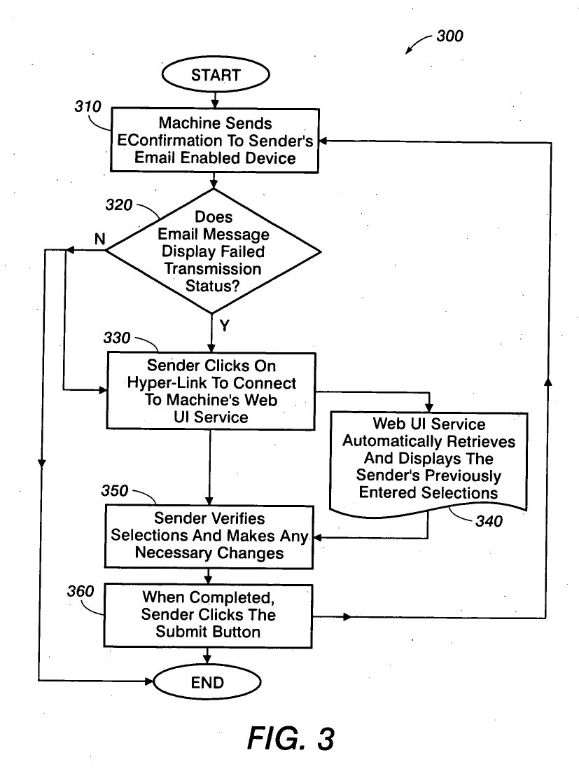

FIG. 3 is a flowchart showing a method 300 for remotely retransmitting a fax using a Web service without having to rescan the same document again, in accordance with an embodiment. The Web service is a user interface service, for example.

In step 310 of method 300, an electronic confirmation is sent to the user, or sender. The electronic confirmation is an email sent to an email address of the user. The electronic confirmation can be received by the user at any email enabled device. An emailed enabled device can include, but is not limited to, a computer, a cellular phone, and a personal digital assistant.

In step 320, it is determined if the fax transmission succeeded or failed. Preferably a link is only added to the email if the fax transmission has failed. In another embodiment, a link is added regardless of whether or not the fax transmission has failed.

In step 330, a link is added to the email and the user selects the link to connect to a Web service of the fax capable printer.

In step 340, a Web service automatically retrieves the fax job information, including selections previously entered by the user.

In step 350, the user verifies the fax job information and can edit the fax job information.

In step 360, the user initiates a retransmission of the fax job. If the fax job information has not been edited to remove the selection of an electronic confirmation, method 300 returns to step 310.

Another embodiment is a method of storing and recalling fax jobs on a fax capable printer. Prior to submitting a fax job, a user can select an option to store a scanned image of a faxed document in a memory on the fax capable printer. The memory of a fax capable computer can include, but is not limited to, the physical memory of the fax capable printer or a database of the fax capable printer. The option of storing a scanned image can be selected with the electronic notification via email option or without the electronic notification via email option. When the option of storing a scanned image is selected, the user can return to the machine sometime later to query the status of the fax transmission. If the fax transmission fails for any reason, the user can easily re-fax the document by retrieving the scanned image of the document from a memory of the fax capable printer without having to rescan the documents.

The memory of the fax capable printer containing the scanned image and other fax job information is called a “mailbox,” for example. On retrieval of the fax job from the mailbox, the machine automatically displays all previously entered selections. This allows the user to quickly confirm all the information, make any necessary changes and re-submit the fax transmission. The option to store a scanned image of a faxed document increases the productivity of the user by removing the burden on the user to physically retrieve the original hard copy of the document. In addition, the option to store a scanned image of a faxed document frees the user from having to rescan the document all over again. Finally, option to store a scanned image of a faxed document is particular convenient for a user who works in a large and open setting, such as manufacturing floor, where access to email is inconvenient or difficult.

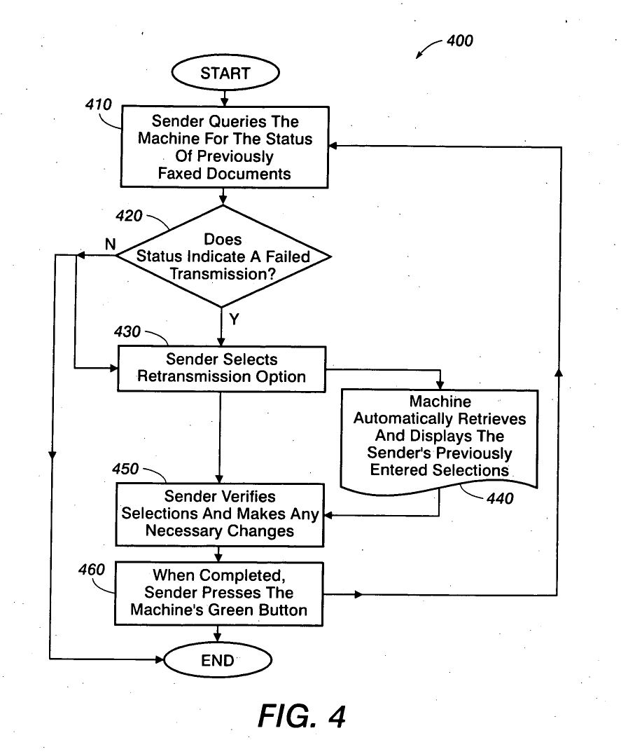

FIG. 4 is a flowchart showing a method 400 for locally retransmitting a fax using information stored on the fax capable printer without having to rescan the same documents again, in accordance with an embodiment.

In step 410 of method 400, a user queries the fax capable printer for the status of a fax job. The user queries the fax capable printer using the user interface of the fax capable printer, for example.

In step 420, it is determined if the fax transmission of the fax job succeeded or failed. Preferably the fax is only retransmitted if the fax transmission failed. In another embodiment the fax can be-retransmitted regardless of whether or not the initial fax transmission failed.

In step 430, a user selects an option to view and retransmit the fax job.

In step 440, the fax capable printer retrieves information about the fax job from a memory of the fax capable printer, including the selections previously entered by the user.

In step 450, the user verifies or edits the selection previously made the user.

In step 460, the user initiates a retransmission of the fax job. If the fax job information has not been edited to remove the selection of the option to store a scanned image of a faxed document in the memory on the fax capable printer, method 400 returns to step 410.

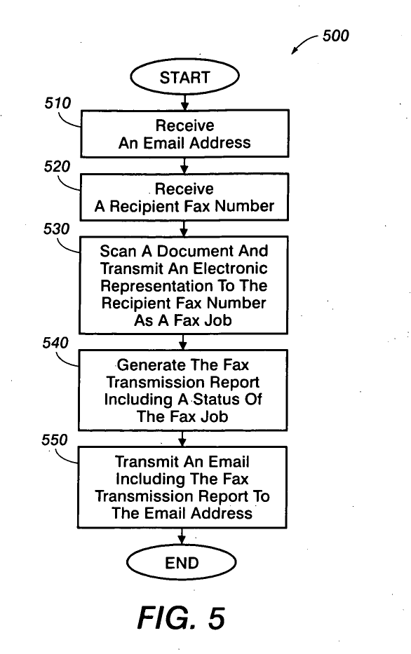

FIG. 5 is a flowchart showing a method 500 for electronically transmitting a fax transmission report for a fax job from a fax capable printer using email, in accordance with an embodiment.

In step 510 of method 500, an email address is received. The email address can be an email address for a user, who is the sender of the fax, or an email address for a recipient of the fax. The email address is obtained from the user. The user enters the email address using a user interface of the fax capable printer, for example.

In another embodiment, the email address is obtained from a database according to login information entered by the user on a user interface of the fax capable printer. The login information includes a user ID and password, for example.

In step 520, a recipient fax number is received. A recipient fax number is a telephone number where the fax is being sent, for example. The recipient fax number is preferably stored in a memory of the fax capable printer.

In step 530, the document is scanned and an electronic representation of the document is transmitted to the recipient fax number as a fax job. In another embodiment, data from scanning the document is stored in a memory of the fax capable printer prior to transmission. A signal to initiate the scanning and transmitting of the document is generated by the user depressing a button on the fax capable printer, for example.

In step 540, the fax transmission report is generated. The fax transmission report includes the status of the fax job.

In step 550, an email including the fax transmission report is transmitted to the email address. In another embodiment, the email includes a link to a Web service of the fax capable printer. The link is, for example, a URL to the Web Service. The Web service can include, but is not limited to, a Web service for retrieving the recipient fax number from the memory, a Web service for displaying the recipient fax number to user, a Web service allowing the user to edit the recipient fax number, or a Web service for transmitting the scanned image to the recipient fax number.

In another embodiment, the recipient fax number is stored in the link to the Web service. The Web service can include, but is not limited to, a Web service for retrieving the recipient fax number from the link, a Web service for displaying the recipient fax number to user, a Web service allowing the user to edit the recipient fax number, or a Web service for transmitting the scanned image to the recipient fax number.

In another embodiment, the fax job is saved in a memory of fax capable printer and is available for recall via a user interface of the fax capable printer. The recipient fax number is stored in the memory. A signal to save the fax transmission report in the memory is received from the user. Another signal to display information from the fax transmission report on a user interface of the fax capable printer is received from the user. The fax transmission report is retrieved from the memory. The information from the fax transmission report is displayed on the user interface of the fax capable printer.

In another embodiment, a signal to transmit the scanned image to the recipient fax number is received from the user. The scanned image is then transmitted to the recipient fax number.

In another embodiment, a signal to edit the recipient fax number is received from the user. The recipient fax number is edited by the user. Another signal to transmit the scanned image to the recipient fax number is received from the user. The scanned image is transmitted to the recipient fax number.

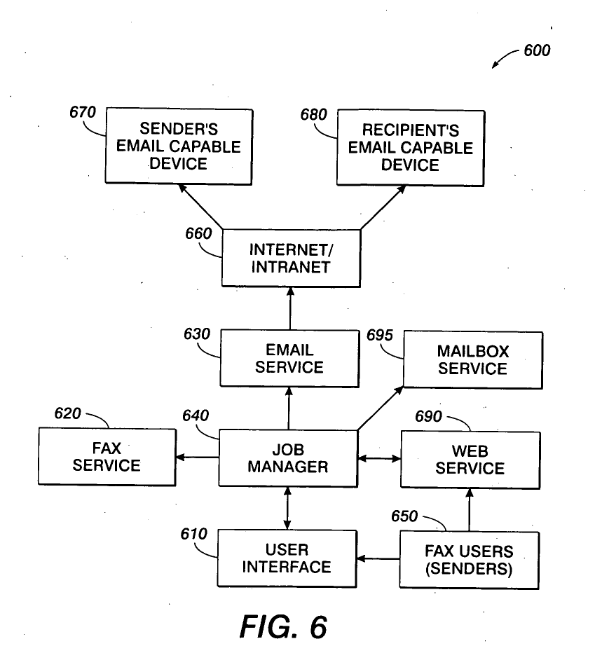

FIG. 6 is a schematic diagram of a system 600 for electronically transmitting a fax transmission report for a fax job from a fax capable printer using email, in accordance with an embodiment. System 600 includes user interface 610, fax service 620, email service 630, and job manager 640. User interface 610, fax service 620, email service 630, and job manager 640 are software components that are executed on one or more processors of the fax capable printer. User interface 610 receives an email address, receives a recipient fax number, and receives a signal to fax a document from user 650. Job manager 640 receives the email address, the recipient fax number, and the signal to fax the document from user interface 610. Job manager 640 transmits the document to the recipient fax number as a fax job by sending the recipient fax number to fax service 620. Job manager 640 monitors fax service 620 for the status of the fax job. Job manager 640 generates the fax transmission report.

The fax transmission report includes the status of the fax job. Job manager 640 transmits an email, which includes the fax transmission report, to the email address by sending the email address and the fax transmission report to email service 630.

Email service 630 sends the email including the transmission report across network 600. Network 660 can include but is not limited to an intranet or the Internet. The email can be sent to the user's email address 670 or the recipient's email address 680.

In another embodiment, job manager 640 places a link to Web service 690 in the email. User 650 can then access Web service 690 by following the link in the email.

In another embodiment, fax service 620 creates a scanned image of the document, stores the scanned image in a memory of the fax capable printer, and transmits an electronic representation of the scanned image to the recipient fax number. Job manager 640 stores the recipient fax number and other information about the fax job in the memory. Mailbox service 695 is used to retrieve the scanned image and all other information about the fax job from the memory. User 650 accesses the scanned image and all other information about the fax job: through user interface 610 and job manager 640.

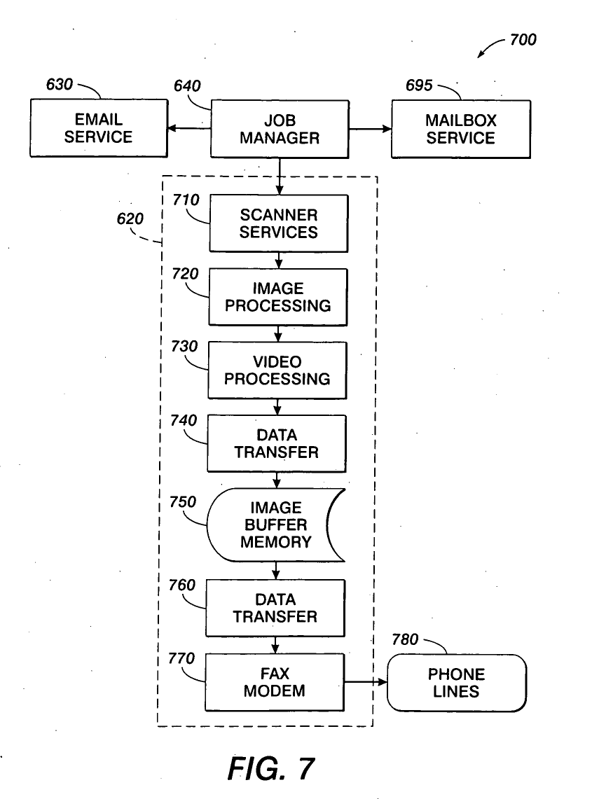

FIG. 7 is a schematic diagram of a system 700 for electronically transmitting a fax transmission report for a fax job from a fax capable printer using email showing the components of fax service 620, in accordance with an embodiment. System 700 includes email service 630, job manager 640, mailbox service 695, and fax service 620. Job manager 640 connects to email service 630, mailbox service 695 and fax service 620. Fax service 620, like all software components described herein, can consist of lower level software components. Fax service 636, for example, includes scanner services 710, image processing component 720, video processing component 730, data transfer component 740, image memory buffer component 750, data transfer component 760, and fax modem component 770. Fax service 620 is additionally connected to phone lines 780 through fax modem component 770.

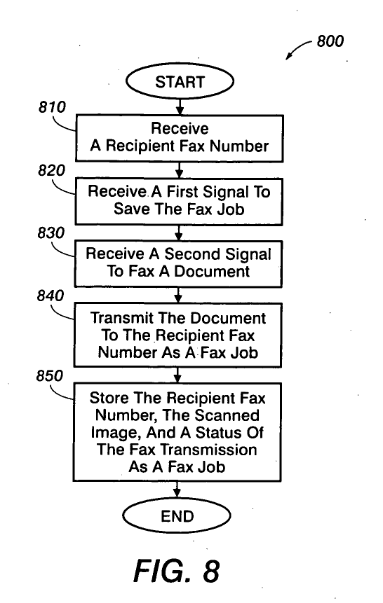

FIG. 8 is a flowchart showing a method 800 for storing a fax job on a fax capable printer, in accordance with an embodiment.

In step 810 of method 800, a recipient fax number is received.

In step 820, a first signal to save the fax job is received.

In step 830, a second signal to fax a document is received.

In step 840, the document is transmitted to the recipient fax number as a fax job. Transmitting the document to the recipient fax number includes creating a scanned image of the document.

In step 850, the recipient fax number, the scanned image, and a status of transmitting the document as a fax job are stored in a memory of the fax capable printer.

In another embodiment, a third signal to the display the status of the fax job is received from a user. The status is retrieved from a memory of the fax capable printer. The status is displayed on a user interface of the fax capable printer.

Systems and methods in accordance with an embodiment disclosed herein can advantageously protect highly sensitive and confidential data. Fax productivity and system performance are improved by only having to scan documents once. User productivity is increased by no longer requiring the user to wait by the fax capable printer to receive a fax transmission report. User productivity is also increased by allowing the user to reconfirm a fax number, retransmit a fax, or delete a fax job using a Web browser.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

The claims can encompass embodiments in hardware, software, or a combination thereof.

What is claimed is:

1. A method for electronically transmitting a fax transmission report for a fax job from a fax capable printer, comprising:
receiving an email address;
receiving a recipient fax number;
scanning a document and transmitting an electronic representation of the document to the recipient fax number as a fax job;
generating the fax transmission report comprising a status of the fax job; and
transmitting an email comprising the fax transmission report to the email address.

2. The method of claim 1, wherein the email address comprises an email address for the user.

3. The method of claim 1, wherein the email address comprises an email address for the recipient.

4. The method of claim 2, wherein receiving the email address for the user comprises obtaining the email address from a database according to login information entered by the user on a user interface of the fax capable printer

5. The method of claim 3, wherein the login information comprises a user ID and password.

6. The method of claim 1, wherein a signal to initiate the scanning and transmitting is generated by the user depressing a button on the fax capable printer.

7. The method of claim 1, wherein data from scanning the document is stored in a memory of the fax capable printer prior to transmission.

8. The method of claim 7, wherein the email comprises a link to a Web service of the fax capable printer.

9. The method of claim 8, wherein the recipient fax number is stored in the memory.

10. The method of claim 9, wherein the Web service comprises one of retrieving the recipient fax number from the memory, displaying the recipient fax number to user, allowing the user to edit recipient fax number, and transmitting the scanned image to the recipient fax number.

11. The method of claim 7, wherein the recipient fax number is stored in the link.

12. The method of claim 11, wherein the Web service comprises one of retrieving the recipient fax number from the link, displaying the recipient fax number to user, allowing the user to edit recipient fax number, and transmitting the scanned image to the recipient fax number.

13. The method of claim 7, further comprising:
storing the recipient fax number in the memory;
receiving a signal to save the fax transmission report in the memory; and
receiving another signal to display information from the fax transmission report on a user interface of the fax capable printer;
retrieving the fax transmission report from the memory; and
displaying the information from the fax transmission report on the user interface.

14. The method of claim 13, further comprising:
receiving a signal to transmit the scanned image to the recipient fax number; and
transmitting the scanned image to the recipient fax number.

15. The method of claim 13, further comprising:
receiving a signal to edit the recipient fax number;
editing the recipient fax number;
receiving a signal to transmit the scanned image to the recipient fax number; and
transmitting the scanned image to the recipient fax number.

16. A system for electronically transmitting a fax transmission report for a fax job from a fax capable printer, comprising:
a user interface of the fax capable printer, wherein the user interface receives an email address, receives a recipient fax number, and receives a signal to fax a document;
a fax service of the fax capable printer;
an email service of the fax capable printer; and
a job manager of the fax capable printer, wherein the job manager (a) receives the email address, the recipient fax number, and the signal to fax the document from the user interface, (b) transmits the document to the recipient fax number as a fax job by sending the recipient fax number to the fax service, (c) monitors the fax service for a status of the fax job, (d) generates the fax transmission report comprising the status, and (e) transmits an email comprising the fax transmission report to the email address by sending the email address and the fax transmission report to the email service.

17. The system of claim 16, wherein the fax service creates a scanned image of the document, stores the scanned image in a memory of the fax capable printer, and transmits an electronic representation of the scanned image to the recipient fax number.

18. The system of claim 17, further comprising a Web service, wherein the job manager places a link to the Web service of the fax capable printer in the email.

19. A method for storing a fax job on a fax capable printer, comprising:
receiving a recipient fax number;
receiving a first signal to save the fax job;
receiving a second signal to fax a document;
transmitting the document to the recipient fax number as a fax job, wherein the transmitting the document comprises creating a scanned image of the document; and
storing the recipient fax number, the scanned image, and a status of the transmitting the document as a fax job in a memory of the fax capable printer.

20. The method of claim 19, further comprising:
receiving a third signal to display the status of the fax job;
retrieving the status from the memory; and
displaying the status.
